(19) United States
(12) Patent Application Publication
(10) Pub. No.: US 2019/0254328 A1
(43) Pub. Date: Aug. 22, 2019

(54) ALGAE BASED FOOD PRODUCT

(71) Applicant: Sean Raspet, Detroit, MI (US)

(72) Inventor: Sean Raspet, Detroit, MI (US)

(21) Appl. No.: 16/281,502

(22) Filed: Feb. 21, 2019

Related U.S. Application Data
(60) Provisional application No. 62/633,431, filed on Feb. 21, 2018.

(51) Int. Cl. A23L 33/105; A23G 1/30; A23L 2/60

(52) U.S. Cl. CPC A23L 33/105; A23L 2/60; A23G 1/30

(57) ABSTRACT

The present disclosure provides for algae-based food products, namely an algae-based food product having an aroma and taste of chocolate. The product may further be prepared using a tempering process to obtain the appearance and consistency of tempered chocolate.

### CLAIM OF PRIORITY

This application claims priority to U.S. Application 62/633,431 filed on Feb. 21, 2018, the contents of which are herein fully incorporated by reference in its entirety.

### FIELD OF THE EMBODIMENTS

The field of the embodiments of the present invention relate to algae-based food products, namely an algae-based food product having an aroma and taste of chocolate.

### BACKGROUND OF THE EMBODIMENTS

Presently, there's an ever-growing need for additional food sources, particularly food sources that are inexpensive to produce and nutritious. Moreover, the global reliance on meat products as the staple of many diets, contributes significantly to the release of greenhouse gases. Thus, there's a need for new foodstuffs that are palatable and nutritious yet less harmful to the environment to produce.

Algae have long been looked to as a potential source of food. While certain types of algae, primarily seaweed, do indeed provide important foodstuffs for human consumption, the promise of algae as a foodstuff has not yet been fully realized. However, there are several species of algae that are used in foodstuffs today, most being macroalgae such as kelp, dulse and sea lettuce. Microalgae, such as spirulina, are grown commercially in open ponds or tanks for use as a nutritional supplement or incorporated in small amounts in various beverages. Other microalgae, including some species of chlorella, are also utilized as a nutritional supplement.

For example, U.S. Patent Application 2010/0303990 pertains to a microalgal biomass high in protein and fiber, wherein the biomass has been manufactured through heterotrophic fermentation. The materials provided herein are useful for the manufacture of meat substitutes and meat enhancers, as well as other food products that benefit from the addition of digestible protein and dietary fiber. Structural properties of foods are enhanced through the use of such materials, including texture and water retention properties. High in protein and fiber food materials of the invention can be manufactured from edible and inedible heterotrophic fermentation feedstocks, including corn starch, sugar cane, glycerol, and depolymerized cellulose.

U.S. Patent Application 2010/0297325 pertains to the creation of food products based on eggs, wherein the productions contain various raw materials made from microalgae in different forms. Some forms include high levels of monounsaturated oil, dietary fiber, carotenoids, and digestible crude protein. Provided herein are methods and compositions for enhancing food stability at elevated temperature during extended periods of storage in hydrated egg products. The microalgae-derived materials are provided as dry or hydrated homogenates made from heterotrophically produced microalgae of varying genera, species and strain. Weight/weight levels of saturated fats and cholesterol are reduced in egg products of the invention, while dietary fiber is increased. Blends of liquid or dried egg with liquid or dried algae are provided, as well as methods of manufacturing and formulating the blends. Unique combinations of egg whites and microalgae are also provided for manufacture of very low cholesterol egg products. In some embodiments, the textural characteristics of powdered eggs are altered to be more like the textural characteristics of liquid eggs through the inclusion of dietary fiber and other moisture-retaining properties of microalgal biomass.

U.S. Patent Application 2010/0297295 pertains to beverages and raw materials for the manufacture thereof, such beverage and raw materials containing microalgae of various species with varying components. Attributes of the microalgal biomass used in the invention include nutrition-providing materials such as carotenoids, dietary fiber, tocotrienols and tocopherols, and varying lipid compositions, particularly low levels of saturated lipids. Attributes of the microalgal biomass used in the invention include structural attributes such as improved mouth feel compared to alternative milk products such as soy milk and rice milk. The novel beverages provide delivery systems for high nutrition materials found in microalgae. The invention provides a new category of finished beverages based on microalgae (such as refrigerated and shelf stable liquids and emulsions) as well as compositions for augmenting properties of current beverages through inclusion of novel microalgae-based materials as ingredients.

The above described algal uses do have drawbacks. For example, algal powders made with algae grown photosynthetically in outdoor ponds or photobioreactors are readily available but have a deep green color and a characteristic unpleasant taste. When formulated into food products or as nutritional supplements, these algal powders impart a visually unappealing green color to the food product or nutritional supplement and further impart an unpleasant fishy or seaweed flavor.

Thus, there remains a need for to produce foodstuffs from algae cheaply and efficiently, at large scale, that are tasty and nutritious. The present invention and its embodiments meet these and other needs.

### SUMMARY OF THE EMBODIMENTS

In general, the present invention and its embodiments provide an algal food product for human consumption that is rich in nutrients with a satisfying taste. Preferably, the present invention and its embodiments provide for a food product that has the taste of chocolate without containing cacao. It is estimated that the demand for chocolate (cacao) will increase two-fold by 2050. However, the cacao trees from which cacao is produced are increasingly threatened by pests, fungal infections, climate change and farmers' lack of access to yield-enhancing fertilizers. One of the solutions so far has been to increase the use of arable land. Unfortunately, rainforests have been cut down to meet the demand for land as well as protected natural parks have been turned into production areas. As a result, previous accumulatively causes additional climate change. Furthermore, once the “new” land (aka previous rainforest) becomes depleted it will face the same problems as the land that is unproductive already at the moment. Thus, the present invention and its embodiments provide a nutritious food product having a distinct chocolate flavor even while containing zero cacao.

In one aspect of the present invention there is an algae-based food product containing an algae-based cocoa butter, an algae-based powder, or flour that contains protein and fiber.

In one embodiment of the present invention the food product contains at least one flavoring agent.

In one embodiment of the present invention the food product contains at least one of a sweetener and a fiber powder.

In one embodiment of the present invention the sweetener and/or the fiber powder comprise about 10% by weight of the food product.

In one embodiment of the present invention the sweetener is erythritol.

In one embodiment of the present invention the algae-based cocoa butter, algae-based flour, are derived from an algae selected from the group consisting of: spirulina, nannochloropsis, chlorella, c. reinhardtii, euglena, and lemna.

### DESCRIPTION OF THE PREFERRED EMBODIMENTS

Reference will now be made in detail to each embodiment of the present invention. Such embodiments are provided by way of explanation of the present invention, which is not intended to be limited thereto. In fact, those of ordinary skill in the art may appreciate upon reading the present specification that various modifications and variations can be made thereto.

The term “about” when used herein means the specified amount plus or minus 2% of the specified value. For example, “about 20%” would mean that the range of 18% to 22% would be encompassed by such a term. If the amount specified is 2% or less than the range extends from 0% to +2% of the specified value. For example, “about 0.5%” would mean that the range of 0% to 2.5% would be encompassed by such a term.

A primary ingredient of the present invention is the cocoa butter equivalents (CBE) namely an algae-based cocoa butter replacement. CBE's exhibit the same general chemical as well as physical properties as the cocoa butter but eliminates many of the difficulties inherent in production of chocolate as well as the lack of nutritional benefits. The CBE may range from about 35% to about 75% by weight of the food product, and is preferably about 40% to about 65% by weight of the food product.

Algal flour of the embodiments of the present invention may be prepared from a concentrated microalgal biomass that has been freeze dried or otherwise dehydrated. Alternatively, they may be mechanically lysed and homogenized and the homogenate spray or flash dried (or otherwise dried). Some forms of algae flour, such as those that are lemna-based may require further milling or refining to reduce particle size prior to use.

The sweeteners utilized in the embodiments of the present invention may include sucralose, aspartame, cyclamate, saccharin, stevia, acesulfame potassium, sugar alcohols, xylitol, thaumatin, tagatose, sorbitol, psicose, polydextrose, pentadin, monellin, monatin, miraculin, mannitol, maltodextrin, maltitol, mabinlin, mogroside, lactitol, isomaltulose, isomalt, inulin, glycerol, isomaltooligosaccharide,glycyrrhizin, fructooligosaccharide, curculin, brazzein, advantame, neotame, monkfruit, and various combinations thereof. A preferred sweetener is erythritol. The sweetener may range in an amount of about 5% to about 25% by weight and more preferably about 20% by weight of the food product.

Other flavoring agents may include various artificial and natural flavors to create a flavor profile of chocolate without containing any cacao. The term “artificial flavor” or “artificial flavoring” means any substance, the function of which is to impart flavor, which is not derived from a spice, fruit or fruit juice, vegetable or vegetable juice, edible yeast, herb, bark, bud, root, leaf or similar plant material, meat, fish, poultry, eggs, dairy products, or fermentation products thereof. Traditional artificial flavoring such as diacetyl, acetylpropinyl, acetoin, isoamyl acetate, benzaldehyde, cinnamaldehyde, ethyl propionate, methyl anthranilate, limonene, ethyl decadienoate, allyl hexanoate, ethyl maltol, ethylvanillin, methyl salicylate, and manazanate may be used.

The term “natural flavor” or “natural flavoring” means the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional. The flavoring agent may be between about 0% and about 2% by weight and more preferably about 0.2% to about 0.5% by weight of the food product.

In a preferred embodiment, the microalgae is a species selected from the group consisting of Parachlorella kessleri, Parachlorella beijerinckii, Neochloris oleabundans, Bracteacoccus, including B. grandis, B. cinnabarinas, and B. aerius, Bracteococcus sp. or Scenedesmus rebescens. Other nonlimiting examples of microalgae species include those species from the group of species and genera consisting of Achnanthes orientalis; Agmenellum; Amphiprora hyaline; Amphora, including A. coffeiformis including A.c. linea, A.c. punctata, A.c. taylori, A.c. tenuis, A.c. delicatissima, A.c. delicatissima capitata; Anabaena; Ankistrodesmus, including A. falcatus; Boekelovia hooglandii; Borodinella; Botryococcus braunii, including B. sudeticus; Bracteoccocus, including B. aerius, B. grandis, B. cinnabarinas, B. minor, and B. medionucleatus; Carteria; Chaetoceros, including C. gracilis, C. muelleri, and C. muelleri subsalsum; Chlorococcum, including C. infusionum; Chlorogonium; Chroomonas; Chrysosphaera; Cricosphaera; Crypthecodinium cohnii; Cryptomonas; Cyclotella, including C. cryptica and C. meneghiniana; Dunaliella, including D. bardawil, D. bioculata, D. granulate, D. maritime, D. minuta, D. parva, D. peircei, D. primolecta, D. salina, D. terricola, D. tertiolecta, and D. viridis; Eremosphaera, including E. viridis; Ellipsoidon; Euglena; Franceia; Fragilaria, including F. crotonensis; Gleocapsa; Gloeothamnion; Hymenomonas; Isochrysis, including I. aff. galbana and I. galbana; Lepocinclis; Micractinium (including UTEX LB 2614); Monoraphidium, including M. minutum; Monoraphidium; Nannochloris; Nannochloropsis, including N. salina; Navicula, including N. acceptata, N. biskanterae, N. pseudotenelloides, N. pelliculosa, and N. saprophila; Neochloris oleabundans; Nephrochloris; Nephroselmis; Nitschia communis; Nitzschia, including N. alexandrina, N. communis, N. dissipata, N. frustulum, N. hantzschiana, N. inconspicua, N. intermedia, N. microcephala, N. pusilla, N. pusilla elliptica, N. pusilla monoensis, and N. quadrangular; Ochromonas; Oocystis, including O. parva and O. pusilla; Oscillatoria, including O. limnetica and O. subbrevis; Parachlorella, including P. beijerinckii (including strain SAG 2046) and P. kessleri (including any of SAG strains 11.80, 14.82, 21.11H9); Pascheria, including P. acidophila; Pavlova; Phagus; Phormidium; Platymonas; Pleurochrysis, including P. carterae and P. dentate; Prototheca, including P. stagnora (including UTEX 327), P. portoricensis, and P. moriformis (including UTEX strains 1441, 1435, 1436, 1437, 1439); Pseudochlorella aquatica; Pyramimonas; Pyrobotrys; Rhodococcus opacus; Sarcinoid chrysophyte; Scenedesmus, including S. armatus and S. rubescens; Schizochytrium; Spirogyra; Spirulina platensis; Stichococcus; Synechococcus; Tetraedron; Tetraselmis, including T. suecica; Thalassiosira weissflogii; and Viridiella fridericiana. Various combinations of the aforementioned algae and other not specifically named herein may further be utilized under the purview of the present invention. In a preferred embodiment, there is up to 90% by weight of the food product comprising algae. In other embodiments, the amount of algae may be up to 75% by weight of the food product. Further, in at least one embodiment, the algae utilized is a combination of lemna, spirulina, and chlorella. The weight ranges of the individual algae types may independently be between about 5% to about 30% by weight.

### EXAMPLE 1

The following example is intended to be representative of an embodiment of the present invention.

| Ingredient | Percent by weight |
|---|---|
| algae-based cocoa-butter replacement | 55.79 |
| powdered erythritol | 21.36 |
| lemna | 8.58 |
| chlorella | 8.58 |
| spirulina | 3.43 |
| lecithin | 1.72 |
| monkfruit | 0.22 |
| flavor | 0.22 |
| color (astaxanthin from algae or other | 0.1 |
| red color such as iron oxide) | |

In the present invention the algae have the advantage of sharing many of the flavor notes associated with chocolate. They thus form a base upon which a smaller amount of flavoring such as artificial flavoring may be added to make the finished product of an identical taste and texture to chocolate.

When the above ingredients are combined, in a similar fashion to traditional chocolates, an algae-based food product having a similar appearance and taste to chocolate can be derived. The present invention and its embodiments may be prepared using a conventional tempering process to obtain the desired appearance and consistency of chocolate. Further, the ingredients described herein may be tempered to create visually appealing and shelf stable foodstuffs. The end product may further be molded, as desired, and packaged.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An algae-based food product comprising:
an algae-based cocoa butter; and
an algae-based flour, wherein the algae-based flour comprises at least one algae-based protein.

2. The food product of claim 1 further comprising:
at least one flavoring agent.

3. The food product of claim 1 further comprising:
at least one of a sweetener and a fiber powder.

4. The food product of claim 3 wherein the sweetener and/or the fiber powder comprise about 20% by weight of the food product.

5. The food product of claim 3 wherein the sweetener is erythritol.

6. The food product of claim 1 wherein the algae-based cocoa butter, algae-based flour, or the at least one algae-based protein are derived from an algae selected from the group consisting of: spirulina, nannochloropsis, chlorella, c. reinhardtii, euglena, and lemna.

7. The food product of claim 1 wherein the algae-based cocoa butter is present in an amount of about 55%.

8. The food product of claim 6 wherein the algae is spirulina, lemna, and chlorella.

9. The food product of claim 8 wherein a weight ratio of chlorella and lemna to spirulina is about 2.5:1.

10. An algae-based food product comprising:
about 55% by weight of an algae-based cocoa butter;
about 20% by weight of at least one sweetener;
about 0.5% by weight of a flavoring agent; and
an algae-based flour,
wherein the algae-based flour comprises at least one algae-based protein and at least one algae-based fiber; and
wherein the algae-based flour comprises a combination of chlorella, spirulina, and lemna.

11. The algae-based food product of claim 10 further comprising:
at least one coloring agent.

12. The food product of claim 10 wherein a weight ratio of chlorella and lemna to spirulina is about 2.5:1.
